(19) United States
(12) Patent Application Publication
(10) Pub. No.: US 2009/0159044 A1
(43) Pub. Date: Jun. 25, 2009

(54) Ignition control system

(75) Inventor: Masakatsu Miyao, Wako-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd.

(21) Appl. No.: 12/314,590

(22) Filed: Dec. 12, 2008

(30) Foreign Application Priority Data
Dec. 21, 2007 (JP) 2007-330061

(51) Int. Cl. F02P 5/152

(52) U.S. Cl. 123/406.37

(57) ABSTRACT

An ignition control system which reduces decrease in output of the internal combustion engine and increase in exhaust gas temperature when one spark plug alone is used for ignition is provided. The ignition control system is used for an engine having cylinders, each of which has two spark plugs. The ignition control system includes a first controller having a first ignition timing control section for controlling ignition timing of a first group of spark plugs including a first spark plug of the two spark plugs in each cylinder and a second controller having a second ignition timing control section for controlling ignition timing of a second group of spark plugs including a second spark plug of the two spark plugs in each cylinder. The first and second ignition timing control sections correct ignition timing according to predetermined parameters when one of the two spark plugs is not used in at least one cylinder.

### TECHNICAL FIELD

The present invention relates to an ignition control system for an internal combustion engine having cylinders each of which is provided with two spark plugs.

### BACKGROUND ART

Each cylinder of an internal combustion engine of aircrafts is provided with two spark plugs for higher reliability. The spark plugs are controlled by an ignition control system.

If one of the two spark plugs gets out of order in a cylinder, ignition control is performed using the other one that is in order. A device for detecting failure of a spark plug is disclosed in JP8-288157A (Japanese Patent Application Laid Open 8-288157), for example. When one spark plug alone is used for ignition, more unburned fuel is delivered and therefore output of the internal combustion engine decreases and exhaust gas temperature increases compared with the case in which the two spark plugs are used.

An object of the present invention is to provide an ignition control system which reduces decrease in output of the internal combustion engine and increase in exhaust gas temperature when one spark plug alone is used for ignition.

### DISCLOSURE OF THE INVENTION

An ignition control system according to the present invention is used for an engine having cylinders, each of which has two spark plugs. The ignition control system includes a first controller having a first ignition timing control section for controlling ignition timing of a first group of spark plugs including a first spark plug of the two spark plugs in each cylinder and a second controller having a second ignition timing control section for controlling ignition timing of a second group of spark plugs including a second spark plug of the two spark plugs in each cylinder. The first and second ignition timing control section correct ignition timing according to predetermined parameters when one of the two spark plugs is not used in at least one cylinder.

The ignition control system according to the present invention has the first and second ignition timing control section which correct ignition timing according to predetermined parameters when one of the two spark plugs is not used in at least one cylinder. Accordingly, when one plug alone is used for ignition, ignition timing is set to the optimal value and therefore decrease in output of the internal combustion engine and increase in exhaust gas temperature can be reduced.

### BRIEF DESCRIPTION OF THE DRAWINGS

FIG. 1 is a view showing a configuration of an ignition control system according to an embodiment of the present invention;

FIG. 2 is a view showing sensors and signal generators installed on and around the internal combustion engine, which are used for an ignition control system;

FIG. 3 is a view showing an example of an ignition timing map for ignition control with 2 spark plugs;

FIG. 4 is a view showing an example of an ignition timing correction map for ignition control with 1 spar plug;

FIG. 5 is a flowchart showing a method in which the ignition control system determines a control mode;

FIG. 6 is a graph showing ignition timing of 2 lane 2 spark plug control mode and that of 1 lane 1 spark plug control mode; and

FIG. 7 is a graph showing values of exhaust gas temperature at the first cylinder in 2 lane 2 spark plug control mode and in 1 lane 1 spark plug control mode.

### BEST MODE FOR CARRYING OUT THE INVENTION

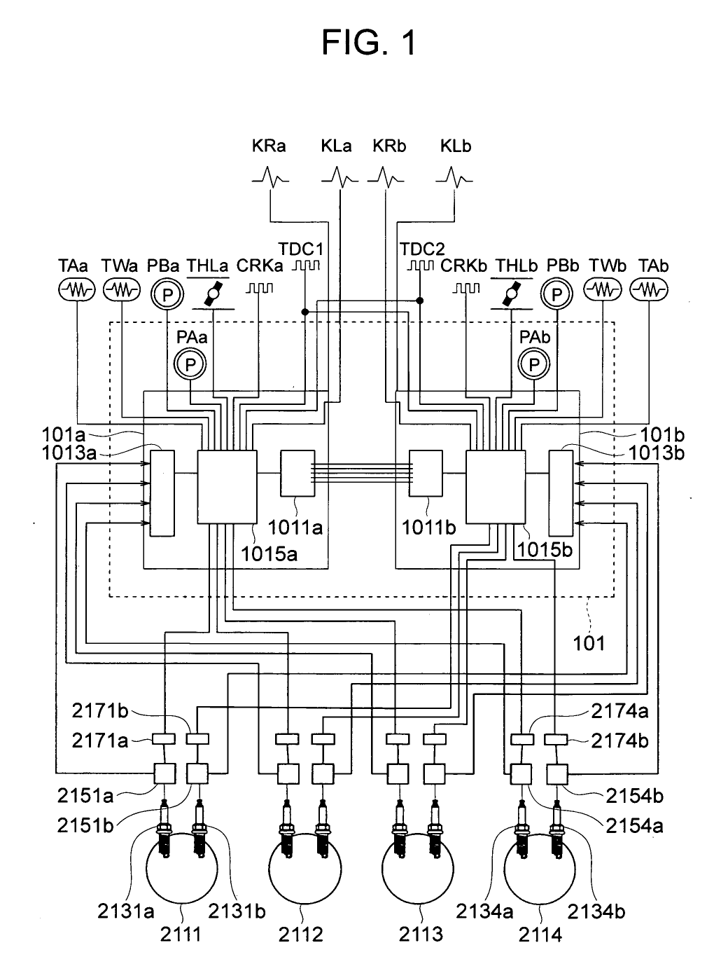

FIG. 1 a view showing a configuration of an ignition control system 101 according to an embodiment of the present invention. The ignition control system 101 is provided with a first controller 101a and a second controller 101b for ignition timing control in a first cylinder 2111, a second cylinder 2112, a third cylinder 2113 and a fourth cylinder 2114.

The first cylinder 2111 is provided with a first spark plug 2131a and a second spark plug 2131b. The first spark plug 2131a is ignited by a first ignition coil 2151a in which high voltage is generated by a first igniter 2171a. The second spark plug 2131b is ignited by a second ignition coil 2151b in which high voltage is generated by a second igniter 2171b. The first controller 101a sends an ignition signal to the first igniter 2171a to control ignition timing of the first spark plug 2131a. The second controller 101b sends an ignition signal to the second igniter 2171b to control ignition timing of the second spark plug 2131b. The first ignition coil 2151a and the second ignition coil 2151b are provided with misfire detecting circuits which send a misfire detection signal respectively to the first controller 101a and the second controller 101b when detecting a misfire.

In a second cylinder 2112, a third cylinder 2113 and a forth cylinder 2114, the first controller 101a controls ignition timing of a first group of spark plugs including the first spark plug in each cylinder while the second controller 101b controls ignition timing of a second group of spark plugs including the second spark plug in each cylinder similarly. Further, the first controller 101a monitors a misfire in the first group of spark plugs while the second controller 101b monitors a misfire in the second group of spark plugs.

The first controller 101a and the second controller 101b capture signals from sensors and signal generators installed on and around the internal combustion engine.

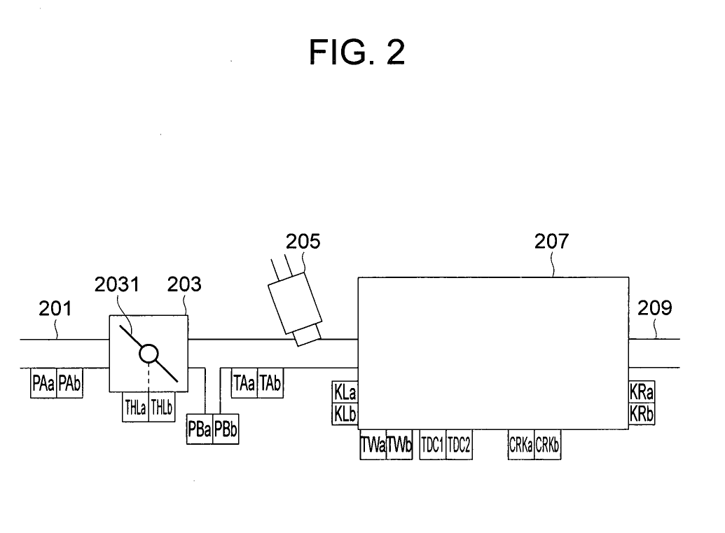

FIG. 2 is a view showing sensors and signal generators installed on and around the internal combustion engine, which are used for an ignition control system 101. Letter “a” with reference numerals of sensors and signal generators shows that the sensors and signal generators are used for the first controller 101a while letter “b” with reference numerals of sensors and signal generators shows that the sensors and signal generators are used for the second controller 101b. Thus, the first controller 101a and the second controller 101b use separate sensors and signal generators for higher reliability.

Atmosphere pressure sensors PAa and PAb are installed upstream of a throttle valve section 203 on an air intake pipe 201. Intake air pressure sensors (also referred to as absolute pressure sensors) PBa and PBb and intake air temperature sensors TAa and Tab are installed downstream of the throttle valve section 203 on the air intake pipe 201. Throttle opening sensors THLa and THLb are installed on a throttle valve 2031 of the throttle valve section 203. A fuel injector 205 is installed between the throttle valve section 203 and each cylinder of the internal combustion engine 207.

Crank angle sensors CRKa and CRKb, TDC pulse generators TDC1 and TDC2, engine coolant temperature sensors TWa and TWb and knock sensors KRa, KRb, KLa and KLb are installed on the internal combustion engine 207. Crank angle sensors CRKa and CRKb deliver pulse signals at a predetermined crank angle period (for example every 30 degrees). TDC pulse generators TDC1 and TDC2 deliver pulse signals which indicate a crank angle of each cylinder reaches a reference crank angle every time the crank shaft rotates by 180 degrees. Knock sensors KRa, KRb, KLa and KLb detect knocking of the internal combustion engine 207. Letter “R” indicates that the sensors with the letter are installed on the “R” (right) bank of the internal combustion engine 207 while Letter “L” indicates that the sensors with the letter are installed on the “L” (left) bank of the internal combustion engine 207.

The first controller 101a captures signals from the sensors and signal generators represented with letter “a” while the second controller 101b captures signals from the sensors and signal generators represented with letter “b”. Signals from TDC pulse generators TDC1 and TDC2 are most important reference signals in operation of the controllers. Accordingly, TDC pulse generators TDC1 and TDC2 are connected in parallel to the first controller 101a and the second controller 101b as shown in FIG. 1 so that control can be continued even if one of the generators gets out of order.

The first controller 101a and the second controller 101b are provided respectively with a first monitoring section 1011a and a second monitoring section 1011b for monitoring the other controller. The first monitoring section 1011a and the second monitoring section 1011b capture sensor signals and obtain states of the processors and send them to each other. When one of the controllers is determined to malfunction, ignition control is performed by the other controller as described later.

The first controller 101a and the second controller 101b are provided respectively with a first misfire detecting section 1013a and a second misfire detecting section 1013b. When a misfire is detected in any one of the cylinders, an ignition control mode is changed as described later. An ignition control mode will also be described later.

The first controller 101a and the second controller 101b are provided respectively with a first ignition timing control section 1015a for controlling ignition timing of the first group of spark plugs including the first spark plug in each cylinder and a second ignition timing control section 1015b for controlling ignition timing of the second group of spark plugs including the second spark plug in each cylinder.

The first ignition timing control section 1015a uses signals from the sensors and signal generators represented with letter “a”. The first ignition timing control section 1015a receives signals from the first monitoring section 1011a and the first misfire detecting section 1013a. The second ignition timing control section 1015b uses signals from the sensors and signal generators represented with letter “b”. The second ignition timing control section 1015b receives signals from the second monitoring section 1011b and the second misfire detecting section 1013b.

First, an ignition control mode for the case in which the first controller 101a, the second controller 101b and all spark plugs are in order will be described. The ignition control mode is referred to as 2 lane 2 spark plug control mode. A lane means a channel of the ignition control system. An ignition timing map (basic ignition timing map) for 2 spark plugs in which ignition timing (ignition angle) is determined for various engine rotational speeds and various values of intake air pressure such that an engine output is maximized is prepared in advance. The first ignition timing control section 1015a and the second ignition timing control section 1015b calculate an engine rotational speed based on captured crank angle pulse signals and TDC pulse signals. Then using the engine rotational speed and a captured measurement of intake air pressure, they determine ignition timing based on the ignition timing map for ignition control with 2 spark plugs. The first ignition timing control section 1015a and the second ignition timing control section 1015b generate ignition signals at ignition timings based on crank angle pulse signals and internal signals of the controllers and send the ignition signals to the first igniter 2171a and the second igniter 2171b for setting ignition timings. When knocking is detected by a knock sensor after ignition timing is set based on the ignition timing map for ignition control with 2 spark plugs, ignition timing is delayed to the limit angle at which knocking is not detected by the knock sensor.

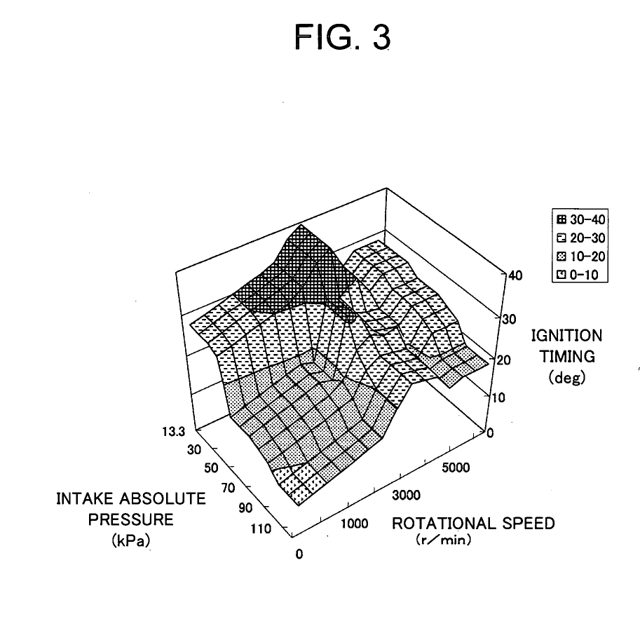

FIG. 3 is a view showing an example of the ignition timing map for ignition control with 2 spark plugs.

Next, an ignition control mode for the case in which a misfire has occurred at one spark plug in any cylinder and the spark plug cannot be used will be described. The ignition control mode is referred to as 2 lane 1 spark plug control mode. The first ignition timing control section 1015a and the second ignition timing control section 1015b use respectively the first misfire detecting section 1013a and the second misfire detecting section 1013b to detect a misfire of spark plugs in each cylinder. When a misfire is detected at a spark plug in any one of the cylinders, 1 spark plug control is performed for the cylinder. An ignition timing map for ignition control with 1 spark plug in which correction amount of ignition timing (crank angle for ignition) is determined for various engine rotational speeds and various values of intake air pressure is prepared in advance. In the other cylinders 2 spark plug control is performed.

Correction amount in the ignition timing correction map for ignition control with 1 spar plug is determined based on the idea described below. In engines designed basically for 2 point ignition (for example, in which two spark plugs are located at positions symmetrically separate from the center of the combustion chamber), when a misfire has occurred at a spark plug and the other spark plug which is located a position separate from the center of the combustion chamber is used for 1 point ignition, a flame propagation distance (a distance at which flame propagation occurs) increases. Accordingly, when ignition timing is set based on the ignition timing map for ignition control with 2 spark plugs, injected fuel is delivered before it has been completely burned and therefore an engine output decreases. Under the situation mentioned above, if ignition timing based on the ignition timing map for ignition control with 2 spark plugs is advanced to the extent that knocking will not occur for 1 spark plug control, unburned fuel which is otherwise delivered can be burned before being delivered and decrease in engine output will be reduced.

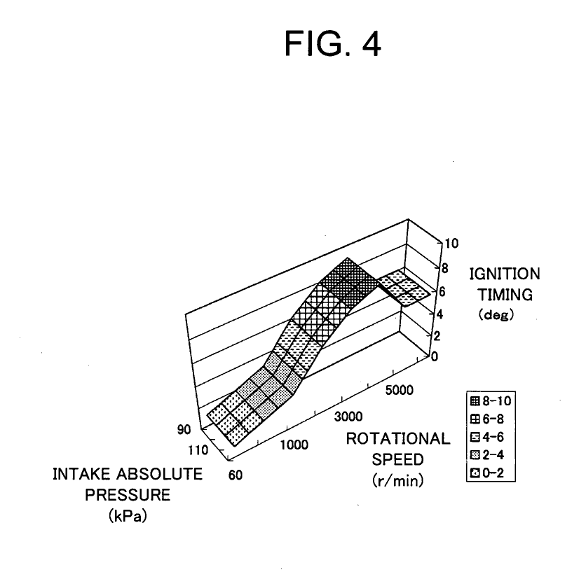

FIG. 4 is a view showing an example of the ignition timing correction map for ignition control with 1 spar plug. For example, the ignition timing correction map for ignition control with 1 spar plug includes data for the case in which intake air absolute pressure is 90 kPa or more alone. If a misfire occurs and the engine output decreases when the engine is not at full throttle, the engine output can be increased by operating the engine toward full throttle. However, if a misfire occurs when the engine is around at full throttle, decrease in the engine output cannot be avoided. Accordingly, correction of ignition timing should be performed to recover the engine output when the engine is around at full throttle (intake air absolute pressure is 90 kPa or more). The correction of ignition timing may be performed when the throttle opening sensors THLa and THLb indicate values equal to or greater than a predetermined one. An amount of correction of ignition timing may be determined based on an equation including values of engine rotational speed and intake air pressure as parameters instead of the ignition timing correction map.

Next, an ignition control mode for the case in which one of the first controller 101a and the second controller 101b is not in order will be described. The ignition control mode is referred to as 1 lane 1 spark plug control mode. The first controller 101a and the second controller 101b are informed respectively by the first monitoring section 1011a and the second monitoring section 1011b that the other controller is not in order. In the 1 lane 1 spark plug control mode the controller in order performs ignition control using a single plug in each cylinder. That is, in each cylinder 1 spark plug control is performed by the controller in order using the ignition timing correction map for ignition control with 1 spar plug.

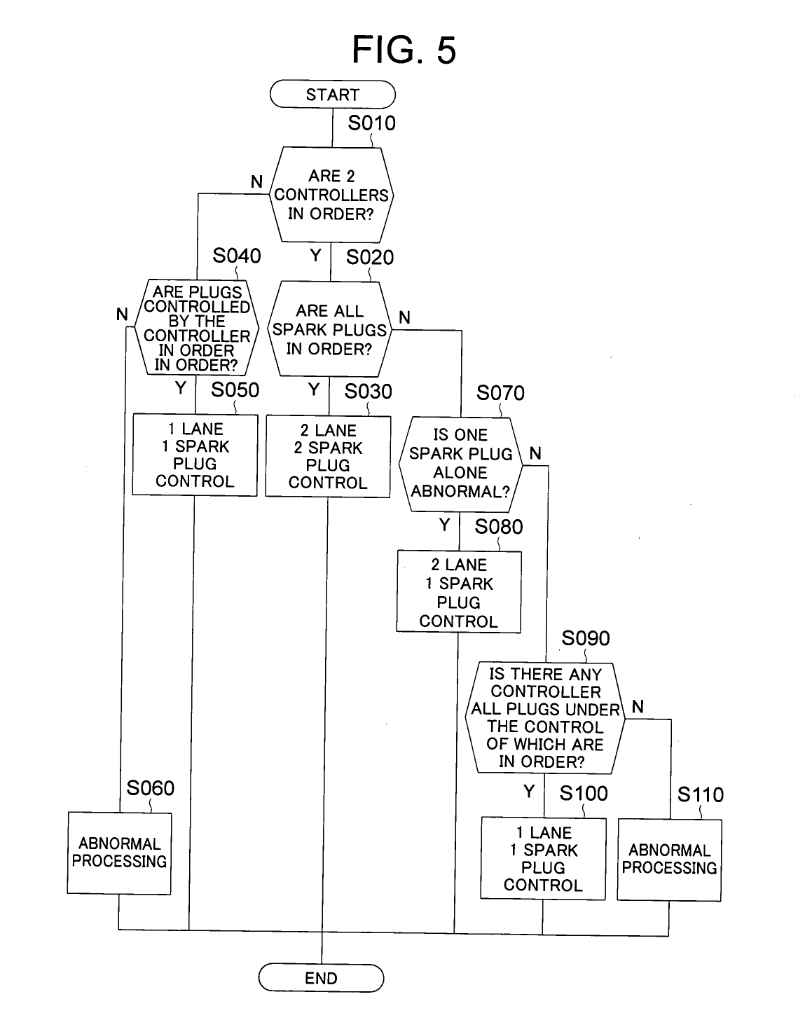

FIG. 5 is a flowchart showing a method in which the ignition control system 101 determines a control mode.

In step S010 the first monitoring section 1011a and the second monitoring section 1011b determine whether the first controller 101a and the second controller 101b are in order. If both of the two controllers are determined to be in order, the process goes to step S020. If one of the two controllers is determined to be not in order, the process goes to step S040.

In step S020 the first misfire detecting section 1013a and the second misfire detecting section 1013b determine whether the spark plugs are in order or not. If all the spark plugs are determined to be in order, the process goes to step S030. If any of the spark plugs are determined to be not in order, the process goes to step S070.

In step S030 the 2 lane 2 spark plug control mode is selected.

In step S040 it is determined whether all the spark plugs monitored by the misfire detecting section of the controller in order are in order or not. If all the spark plugs monitored by the misfire detecting section of the controller in order are determined to be in order, the process goes to S050. If any of the spark plugs monitored by the misfire detecting section of the controller in order are determined to be not in order, the process goes to S060.

In step S050 the 1 lane 1 spark plug control mode is selected.

In step S060 abnormal processing is performed. The abnormal processing is, for example, ignition control performed only for cylinders with two spark plugs in order.

In step S070 the first misfire detecting section 1013a and the second misfire detecting section 1013b respectively determine whether one plug alone is out of order. If it is determined that one plug alone is out of order, the process goes to step S080. If it is determined that two or more plugs are out of order, the process goes to step S090.

In step S080 the 2 lane 1 spark plug control mode is selected.

In step S090 each of the first misfire detecting section 1013a and the second misfire detecting section 1013b determines whether all the spark plugs under the control of each controller are in order or not. If all the spark plugs under the control of each controller are in order, the process goes to S100. If at least one of the spark plugs under the control of each controller is not in order, the process goes to S110.

In step S100 the 1 lane 1 spark plug control mode using the controller all the spark plugs under the control of which are in order is selected.

In step S110 abnormal processing is performed. The abnormal processing is, for example, ignition control performed only for cylinders with two spark plugs in order.

Performance of the internal combustion engine under the control modes mentioned above will be described below. The performance of the internal combustion engine is represented by values at full throttle (full load at the engine rotational speed) and with a fixed air-fuel ratio of 12.5.

Table 1 shows decrease in engine output of 1 lane 1 spark plug control mode with respect to 2 lane 2 spark plug control mode. With respect to output in 2 lane 2 spark plug control mode, output in 1 lane 1 spark plug control mode (without correction) decreases by up to 9% while output in 1 lane 1 spark plug control mode (with correction) decreases by up to 3%. Thus, decrease in output is reduced by correction.

TABLE 1

| | | Engine rotational speed (r/min) | | | |
|---|---|---|---|---|---|
| | | 2000 | 3000 | 4000 | 5000 |
| Decrease | 1 lane 1 spark plug | 9 | 6 | 4 | 9 |
| in output | (without correction) | | | | |
| (%) | 1 lane 1 spark plug | 3 | 3 | 2 | 3 |
| | (with correction) | | | | |

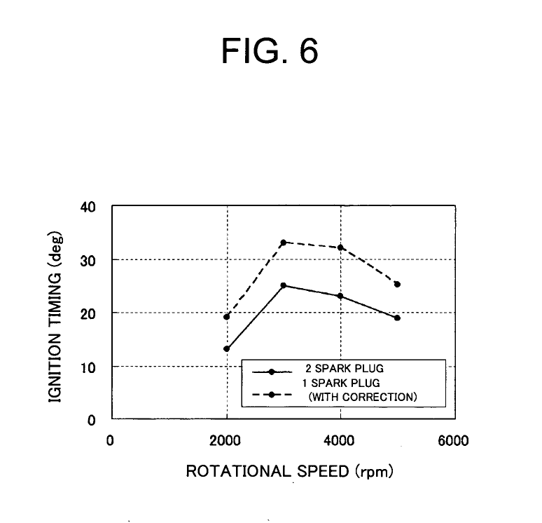

FIG. 6 is a graph showing ignition timing of 2 lane 2 spark plug control mode and that of 1 lane 1 spark plug control mode. Ignition timing is represented in an advanced crank angle (a crank angle in advanced direction) with respect to the reference crank angle of each cylinder. An amount of correction ranges from 6 degrees to 9 degrees.

Table 2 shows decrease in engine output of 2 lane 1 spark plug control mode with correction and that without correction. With respect to output in 2 lane 2 spark plug control mode, output in 2 lane 1 spark plug control mode (without correction) decreases by up to 2.2% while output in 2 lane 1 spark plug control mode (with correction) decreases by up to 0.8%. Thus, decrease in output is reduced by correction.

TABLE 2

| | | Engine rotational speed (r/min) | | | |
|---|---|---|---|---|---|
| | | 2000 | 3000 | 4000 | 5000 |
| Decrease | 2 lane 1 spark plug | 2.2 | 1.6 | 1.0 | 2.2 |
| in output | (without correction) | | | | |
| (%) | 2 lane 1 spark plug | 0.7 | 0.6 | 0.4 | 0.8 |
| | (with correction) | | | | |

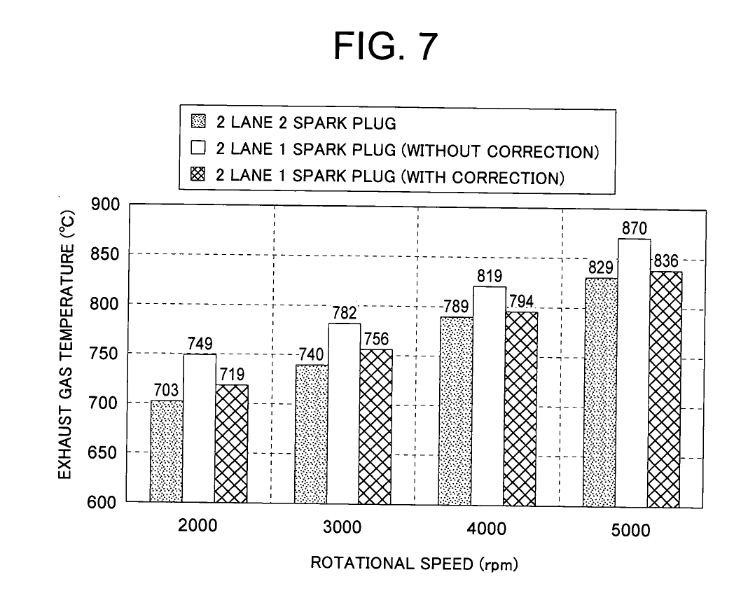

FIG. 7 is a graph showing values of exhaust gas temperature at the first cylinder in 2 lane 2 spark plug control mode and in 2 lane 1 spark plug control mode. FIG. 7 also shows values of exhaust gas temperature at the first cylinder in 2 lane 1 spark plug control mode without correction according to the ignition timing correction map for ignition control with 1 spark plug. With respect to exhaust gas temperature in 2 lane 2 spark plug control mode, exhaust gas temperature in 2 lane 1 spark plug control mode (without correction) increases by up to 46 degrees while exhaust gas temperature in 2 lane 1 spark plug control mode (with correction) increases by up to 16 degrees. Thus, increase in exhaust gas temperature is reduced by correction.

According to the embodiment of the present invention described above, decrease in engine output and increase in exhaust gas temperature can be reduced. Each of the embodiments is featured as below.

In an ignition control system according to an embodiment of the present invention, the first and second controllers respectively have a first monitoring section and a second monitoring sections each of which determines whether the other controller is in order or not. When one of the controllers is determined to be not in order, one of the first and second ignition timing control sections in the controller in order does not use spark plugs under the control of the controller which has been determined to be not in order and uses spark plugs under the control of the controller in order alone and corrects ignition timing according to the predetermined parameters.

According to the present embodiment, even when one of the controllers is not in order and ignition is performed by one plug alone in each cylinder, decrease in output of the internal combustion engine and increase in exhaust gas temperature can be reduced.

In an ignition control system according to another embodiment of the present invention, the first ignition timing control section has a first misfire detecting section for detecting a misfire in the first group of spark plugs and the second ignition timing control section has a second misfire detecting section for detecting a misfire in the second group of spark plugs. When a misfire of a spark plug is detected in at least one cylinder by one of the first and second misfire detecting sections, the misfired spark plug in the cylinder is not used and ignition timing of the other spark plug in the cylinder is corrected according to the predetermined parameters.

According to the present embodiment, even when one of the two plugs in a cylinder is not in order and the other plug alone is used for ignition, decrease in output of the internal combustion engine and increase in exhaust gas temperature can be reduced.

In an ignition control system according to another embodiment of the present invention, the first and second ignition timing control sections correct ignition timing according to a map prepared using engine rotational speed and intake air pressure as parameters.

According to the present embodiment, ignition timing is controlled according to the map prepared using engine rotational speed and intake air pressure as parameters. Accordingly, decrease in output of the internal combustion engine and increase in exhaust gas temperature can be reduced under various operational states of the engine.

In an ignition control system according to another embodiment of the present invention, the first and second ignition timing control sections correct ignition timing determined by engine rotational speed and intake air pressure such that ignition timing is advanced by a predetermined amount (for example, based on such a map as shown in FIG. 4 in which ignition timing is determined according to engine rotational speed and intake air absolute pressure) compared with the case in which the two spark plugs are used.

According to the present embodiment, unburned fuel which is delivered can be reduced when one spark plug alone is used. Accordingly, decrease in output of the internal combustion engine and increase in exhaust gas temperature can be reduced.

In an ignition control system according to another embodiment of the present invention, when knocking is detected in the engine, the first and second ignition timing control sections delay ignition timing to a limit crank angle at which knocking is not detected.

According to the present embodiment, ignition timing can be controlled in a range in which knocking does not occur.

We claim:

1. An ignition control system for an engine having cylinders, each of which has two spark plugs, the ignition control system comprising:
a first controller having a first ignition timing control section for controlling ignition timing of a first group of spark plugs including a first spark plug of the two spark plugs in each cylinder;
a second controller having a second ignition timing control section for controlling ignition timing of a second group of spark plugs including a second spark plug of the two spark plugs in each cylinder,
wherein the first and second ignition timing control sections correct ignition timing according to predetermined parameters when one of the two spark plugs is not used in at least one cylinder.

2. An ignition control system according to claim 1, wherein the first and second controllers respectively have a first monitoring section and a second monitoring sections each of which determines whether the other controller is in order or not and when one of the controllers is determined to be not in order, one of the first and second ignition timing control sections in the controller in order does not use spark plugs under the control of the controller which has been determined to be not in order and uses spark plugs under the control of the controller in order alone and corrects ignition timing according to the predetermined parameters.

3. An ignition control system according to claim 1, wherein the first ignition timing control section has a first misfire detecting section for detecting a misfire in the first group of spark plugs and the second ignition timing control section has a second misfire detecting section for detecting a misfire in the second group of spark plugs and when a misfire of a spark plug is detected in at least one cylinder by one of the first and second misfire detecting sections, the misfired spark plug in the cylinder is not used and ignition timing of the other spark plug in the cylinder is corrected according to the predetermined parameters.

4. An ignition control system according to claim 1, wherein the first and second ignition timing control sections correct ignition timing according to a map prepared using engine rotational speed and intake air pressure as parameters.

5. An ignition control system according to claim 3, wherein the first and second ignition timing control sections correct ignition timing determined by engine rotational speed and intake air pressure such that ignition timing is advanced by a predetermined amount compared with the case in which the two spark plugs are used.

6. An ignition control system according to claim 1, wherein when knocking is detected in the engine, the first and second ignition timing control sections delay ignition timing to a limit crank angle at which knocking is not detected.
